(19) United States
(12) Patent Application Publication
(10) Pub. No.: US 2009/0276118 A1
(43) Pub. Date: Nov. 5, 2009

(54) METHOD AND APPARATUS FOR PROCESSING TRIP INFORMATION AND DYNAMIC DATA STREAMS, AND CONTROLLER THEREOF

(75) Inventors: Steven Shen, Yunlin County (TW); Chia-Chung Chen, Taichung County (TW); Fu-Ming Jheng, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: FlexMedia Electronics Corp., Hsinchu County (TW)

(21) Appl. No.: 12/146,454

(22) Filed: Jun. 26, 2008

(30) Foreign Application Priority Data
May 5, 2008 (TW) 97116577

(51) Int. Cl. G06F 19/00; H04N 7/00

(52) U.S. Cl. 701/35; 348/552

(57) ABSTRACT

A method for processing trip information and dynamic data streams are provided, and includes the following steps. (1) A dynamic data stream including a plurality of video frames is received. (2) Plural batches of trip information are received. (3) At least one batch of trip information and at least one corresponding video frame of the dynamic data stream are taken to construct trip video data. Therefore, when a user playbacks the trip video data, the user can simultaneously see the video frame and obtain the corresponding trip information thereof.

### CROSS-REFERENCE TO RELATED APPLICATION

This application claims the priority benefit of Taiwan application serial no. 97116577, filed on May 5, 2008. The entirety of the above-mentioned patent application is hereby incorporated by reference herein and made a part of specification.

### BACKGROUND OF THE INVENTION

1. Field of the Invention

The present invention relates to a method and an apparatus for generating image data, and a controller thereof, in particular, to a method and an apparatus for processing trip information and dynamic data streams to generate trip video data, and a controller thereof.

2. Description of Related Art

Due to the progress of global positioning system (GPS), currently, many automobiles are equipped with navigation equipments, which allow drivers to acquire road conditions, locations, and ways to destinations. In addition, the high development of video recording equipments also allows people to freely record images in sight and generate video streams.

FIG. 1 is a schematic view of components of a conventional video stream. Referring to FIG. 1, a video stream generally consists of a plurality of video frames 10, 11, 12, . . . , 1n. The video frames 10, 11, 12, . . . , 1n also include headers 100, 110, 120, . . . , 1n0 or a plurality of redundant bits, respectively. Therefore, when the conventional video stream is played back, the headers 100, 110, 120, . . . , 1n0 or a plurality of redundant bits of the video frames 10, 11, 12, . . . , 1n will be decoded, so as to normally playback the video frames 10, 11, 12,..., 1n. In other words, it is the headers 100, 110, 120, . . . , 1nO or redundant bits of the video frames 10, 11, 12, . . . , 1n that record the information such as quantization table and time map related to the video frames 10, 11, 12,..., 1n.

In addition to the above conventional video stream, another conventional video stream includes a plurality of video frames and plural batches of video information. Each video information records a file name, file format, video resolution, bit rate, and the like of the corresponding video frame.

Then, FIG. 2 is a schematic view of trip information provided by a conventional navigation system and navigation computer. Referring to FIG. 2, when a transportation tool is traveling or navigating, the trip information provided by the navigation system and navigation computer generally includes a speed, an engine rotation speed (not shown in FIG. 2), a fuel level (not shown in FIG. 2), an engine temperature (not shown in FIG. 2), a longitude/latitude, an altitude, or a time, etc. The speed includes a velocity and a traveling direction (for example, represented by an angle included between the traveling direction and the north direction). In addition, the speed, engine rotation speed, fuel level, and engine temperature may be provided by the navigation computer, and the longitude/latitude, altitude, and time may be provided by the navigation system.

Although the video recording equipments and navigation systems have brought people a lot of convenience, navigation systems and video recording equipments in the current market are separate. Although the driver can follow the guidance of the navigation system and navigation computer and record all images that can be seen on a navigating route or a travel route to produce video streams, the trip information (for example, longitude/latitude, altitude, road etc.provided by the navigation system and navigation computer is not synchronously recorded into the video streams. Therefore, when an accident happens or the recorded video streams are played back for certain purposes, it is inconvenient for the user to see the video frame of a certain road or at longitude/latitude position due to the absence of the trip information.

### SUMMARY OF THE INVENTION

Accordingly, the present invention is directed to a method and an apparatus for processing trip information and dynamic data streams, and a controller thereof, so as to allow the user to acquire the corresponding trip information when viewing the video frames.

The present invention provides a method for processing trip information and dynamic data streams, including the following steps. (1) A dynamic data stream having a plurality of video frames is received. (2) Plural batches of trip information are received. (3) At least one batch of trip information and at least one corresponding video frame of the dynamic data stream are taken to construct trip video data.

In an embodiment of the present invention, the above trip video data includes the at least one trip information and a video frame corresponding to the at least one trip information in the dynamic data stream.

In an embodiment of the present invention, the above trip information is embedded into a header or redundant bits of the video frame.

In an embodiment of the present invention, the above trip video data records a link relationship between the at least one trip information and the at least one video frame of the dynamic data stream.

In an embodiment of the present invention, the above dynamic data stream further includes an audio stream. The audio stream includes a plurality of audio signals corresponding to each video frame, and the trip video data further includes an audio signal corresponding to the video frame thereof. The trip information is embedded into a header or redundant bits of the audio signal corresponding to the video frame.

The present invention provides an apparatus for processing trip information and dynamic data streams, which includes a trip information receiving interface, a dynamic data stream generating unit, and a microchip processor. The trip information receiving interface is used to receive plural batches of trip information, and the dynamic data stream generating unit is used to generate a dynamic data stream. The dynamic data stream includes a plurality of video frames. The microchip processor is coupled to the trip information interface and the dynamic data stream generating unit, for taking at least one batch of trip information and at least one corresponding video frame of the dynamic data stream to construct trip video data.

In an embodiment of the present invention, the above dynamic data stream generating unit further includes a video receiving apparatus. The video receiving apparatus is used to receive a plurality of original video frames, reduce sizes of the plurality of original video frames, and encode the original video frames with reduced sizes according to a video standard, so as to generate the dynamic data stream.

In an embodiment of the present invention, the above dynamic data stream generating unit further includes a video receiving apparatus and an audio receiving apparatus. The video receiving apparatus is used to receive a plurality of original video frames, reduce sizes of the plurality of original video frames, and encode the original video frames with reduced sizes according to a video standard, so as to generate a video stream. The video stream includes the plurality of video frames. The audio receiving apparatus is coupled to the video receiving apparatus, for receiving a plurality of original audio signals and encoding the plurality of original audio signals according to an audio standard, so as to generate an audio stream. The video receiving apparatus is further used to take the video stream and the audio stream to construct the dynamic data stream.

The present invention provides a controller, which is adapted for processing trip information and dynamic data streams, which includes a micro-processing unit and a memory unit. The memory unit is coupled to the micro-processing unit. The micro-processing unit is used to control other units connected to the controller, and the memory unit stores program codes. When the program codes are executed, the micro-processing unit controls the other units connected to the controller to perform the following steps. (1) A dynamic data stream having a plurality of video frames is received. (2) Plural batches of trip information are received. (3) At least one batch of trip information and at least one corresponding video frame of the dynamic data stream are taken to construct trip video data.

The present invention provides a method and an apparatus for processing trip information and dynamic data streams, and a controller thereof, so as to generate trip video data including the trip information. Therefore, the user can retrieve the corresponding video frames according to the trip information or time when the content of the trip video data is played back, so that the user can retrieve the video frames conveniently. In addition, since the trip video data contains the trip information, in the course of the playback, the trip information and video frames can be synchronously displayed, thereby achieving a better monitoring performance.

In order to make the foregoing features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of components of a conventional video stream.

FIG. 2 is a schematic view of trip information provided by a conventional navigation system and navigation computer.

FIG. 3A is a schematic view of a method for processing trip information and dynamic data streams according to an embodiment of the present invention.

FIG. 3B is a schematic view of a method for processing trip information and dynamic data streams according to an embodiment of the present invention.

FIG. 4 is a schematic view of another method for processing trip information and dynamic data streams according to an embodiment of the present invention.

FIG. 5 is a flow chart of a method for processing trip information and dynamic data streams according to an embodiment of the present invention.

FIG. 6 is a system block diagram of an apparatus for processing trip information and dynamic data streams according to an embodiment of the present invention.

FIG. 7 is a controller for processing trip information and dynamic data streams according to an embodiment of the present invention.

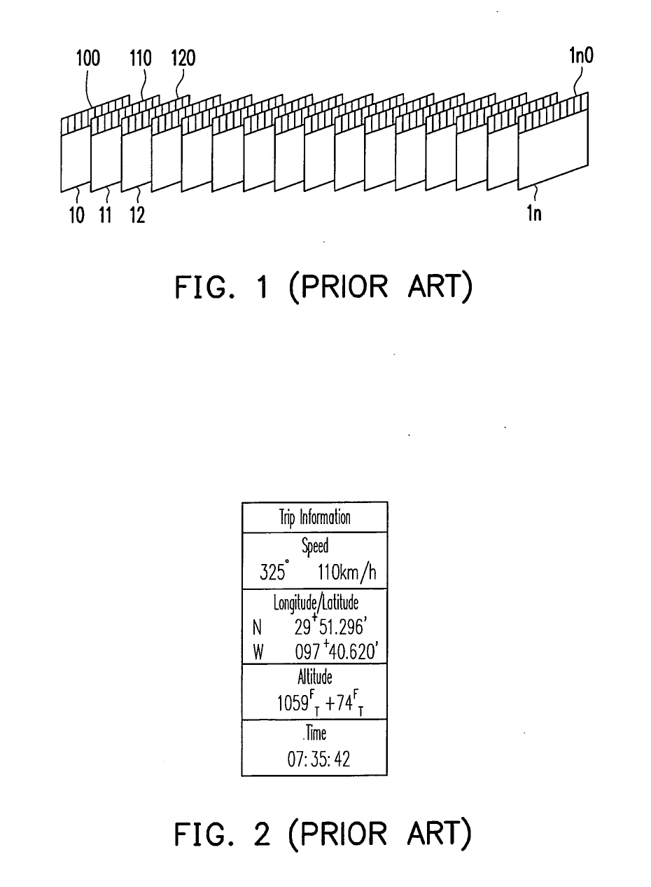

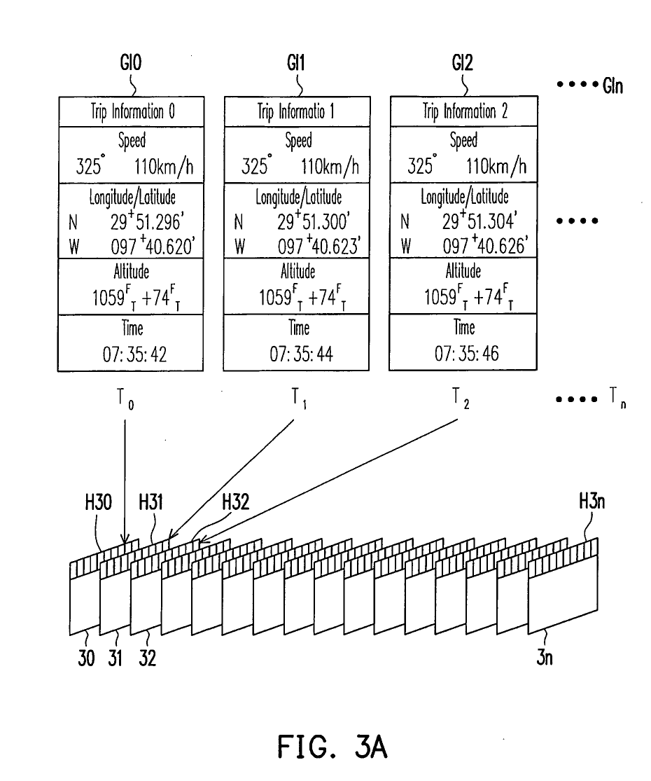

### DESCRIPTION OF THIS EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

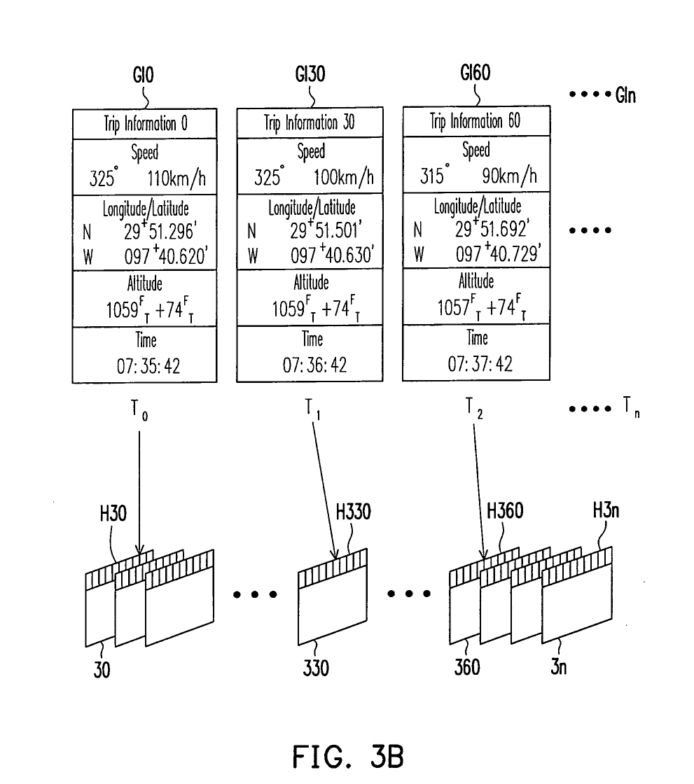

FIG. 3A is a schematic view of a method for processing trip information and dynamic data streams according to an embodiment of the present invention. Referring to FIG. 3A, a dynamic data stream includes a video stream. The video stream includes a plurality of video frames 30, 31, 32, . . . , 3n, and the video frames 30-3n include headers H30, H31, H32, . . . , H3n and redundant bits, respectively.

In the method of this embodiment, during the video recording, the method receive plural batches of trip information GI0-GIn provided by a navigation system at the same time and sequentially embed the trip information GI0-GIn into headers 300, 310, 320, . . . , 3n0 or redundant bits of the video frames 30, 31, 32, . . . , 3n so as to generate trip video data.

The trip information GI0-GIn may include a speed, a longitude/latitude, an altitude, and a time, and so on. The speed includes a velocity and a traveling direction (for example, represented by an angle included between the traveling direction and the north direction). In addition, the video frames 30-3n respectively correspond to the plural trip information GI0-GIn at time T₀-Tₙ.

The trip information in this embodiment is not intended to limit the present invention. As described in the prior art, the trip information may include a speed, an engine rotation speed, a fuel level, an engine temperature, a longitude/latitude, an altitude, or a time, or the like. In addition, the speed, engine rotation speed, fuel level, and engine temperature may be provided by a navigation computer, and the longitude/latitude, altitude, and time may be provided by the navigation system. In short, the trip information may include geographic information or status of a navigator, for example, the information such as the rotation speed, fuel level, or engine temperature that can be recorded by a traveling computer of a vehicle. It should be understood that the method of this embodiment may also be applied to vehicles such as aircrafts or vessels. Definitely, the trip information may also contain only the geographic information.

After the trip video data is generated from the received video streams and trip information by the use of the method of the above embodiment, the user can obtain corresponding trip information from each video frame when the trip video data is played back. In the above method, a batch of corresponding trip information is embedded into the header or redundant bits of each video frame, which, however, is not intended to limit the present invention. In order to reduce the quantity of operations and to avoid too many errors in the trip information displayed in the course of the playback, another implementation is provided to embed a batch of corresponding trip information into the header or redundant bits of a video frame at an interval of 30 frames.

Generally speaking, one batch of geographic information in the trip information is provided per second, while 30 video frames are displayed per second, so one batch of trip information per 30 video frames can meet the requirements in general cases. FIG. 3B is a schematic view of a method for processing trip information and dynamic data streams according to an embodiment of the present invention. Referring to FIG. 3B, 30 video frames correspond to one batch of trip information, i.e., the trip information GI0, GI30, GI60, . . . , GIn are sequentially embedded into the headers H30, H330, H360, . . . , H3n or redundant bits of the video frames 30, 330, 360, . . . , 3n.

In short, the user can set or write related programs to control which video frames have the headers or redundant bits embedded with the corresponding trip information, and implementation method for embedding the corresponding trip information into headers or redundant bits of those video frames are not intended to limit the present invention. Therefore, the number of the trip information is not particularly limited. In other words, the number of the trip information may be smaller than, equal to, or greater than the number of the video frames. However, in most cases, the number of the trip information is smaller than or equal to the number of the video frames.

In addition, the dynamic data stream may also include an audio stream or a video stream. Although the above method is used to embed the trip information into the header or redundant bits of the corresponding video frame, which, however, is not intended to limit the present invention. The trip information may be embedded into the audio stream in another manner. The audio stream includes a plurality of audio signals corresponding to each video frame. The trip video data further includes an audio signal corresponding to the video frame. The trip information is embedded into the header or redundant bits of the audio signal corresponding to the video frame.

The user can obtain the corresponding trip information from each video frame when the video stream is played back, as long as the trip information embedded in the audio stream can be decoded and the corresponding video frames can be found in decoding. The audio stream includes a plurality of audio signals corresponding to each video frame. The trip video data further includes an audio signal corresponding to the video frame. The trip information is embedded into the header or redundant bits of the audio signal corresponding to the video frame.

In practical application, the video standard of the video stream may be the Motion-JPEG standard, ITU-T video standard, MPEG-1 standard, MPEG-2 standard, MPEG-4 standard, or Xvid standard. The audio standard of the audio stream may be the MP3 audio standard, AAC audio standard, WMA audio standard, WAV audio standard, or OGG audio standard. However, selection of the above standards is not intended to limit the present invention.

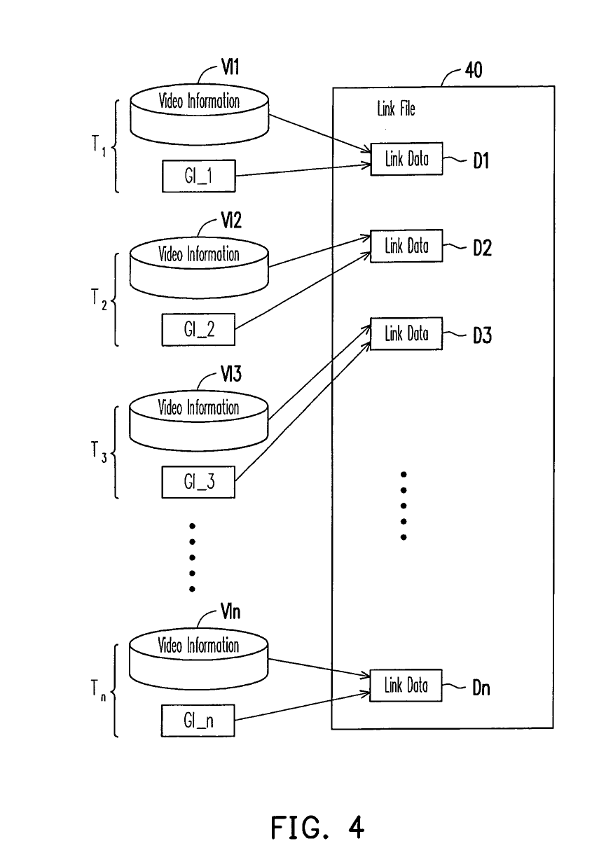

FIG. 4 is a schematic view of another method for processing trip information and dynamic data streams according to an embodiment of the present invention. Referring to FIG. 4, the dynamic data stream is a video stream. The video stream includes video information VI1-VIn and a plurality of video frames (not shown in FIG. 4). Each video information VI1-VIn records the related information of the corresponding video frame, for example, the file format and video resolution, and the like.

In this embodiment, the method includes generating multiple link data D1-Dn for the video information VI1-Vin and the corresponding trip information GI_1-GI_n, and package the link data D1-Dn into one link file 40. Taking the time T₁ as an example, the video frame corresponding to the video information VI1 is the video frame at the time T₁, and the corresponding trip information is GI_1. Therefore, the method records the link relationship between the video information VI1 and the corresponding trip information GI_1, and package the link relationship and at least a part of the trip information to generate the link data D1. In this embodiment, the link data D1 records the longitude/latitude and time of the trip information and the file name of the corresponding video information, thereby finding out the corresponding video information and the complete trip information through the link information. It should be noted that the link data may record only a part of the trip information, for example, time, longitude/latitude, file name of the corresponding trip information, and file name of the corresponding video information, or the link data may be directly constituted of the trip information and file name of the corresponding video information.

Similarly, at the time Tn, the method records the link relationship between the video information VIn and the corresponding trip information GI_n and package the link relationship and a part of the trip information to generate the link data Dn. Finally, the method packages the link data D1-Dn into one link file 40. Here, the trip video data is the link file.

When the user intends to playback the above video stream, a playback apparatus reads the link file 40 and the video stream, and decode according to the link relationship between the trip information recorded by the link file and the video frame of the dynamic data stream. Thereafter, the playback apparatus displays the video frame and the corresponding trip information at the same time according to the result of decoding.

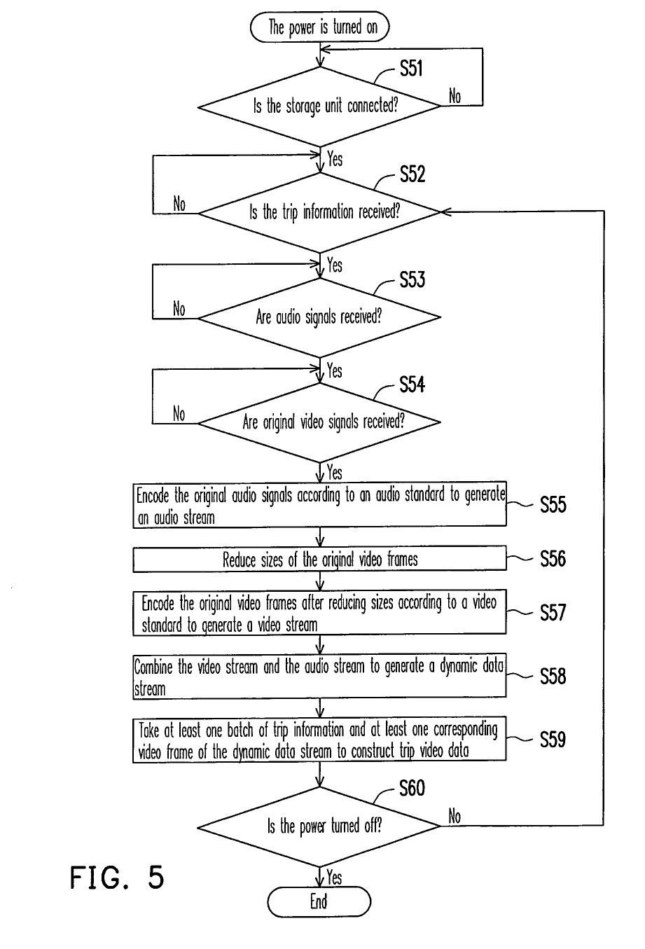

Then, FIG. 5 is a flow chart of a method for processing trip information and dynamic data streams according to an embodiment of the present invention. Referring to FIG. 5, the method is applicable to the video recording apparatus. When the power supply is turned on, the video recording apparatus first performs step S51 to check if a storage unit is connected for storing the recording video and audio. If so, step S52 is performed; otherwise, the user is reminded to connect the storage unit, which lasts until the storage unit and the video recording apparatus are connected. It should be noted that if the video recording apparatus has a built-in storage unit, the step S51 can be omitted.

In step S52, it is checked if the trip information has been received, i.e., if a navigation system or navigation computer that provides the trip information has been connected thereto. If so, step S53 is performed; otherwise, step S53 will not be performed until the navigation system or navigation computer that provides the trip information has been connected thereto. In step S53, it is checked if the audio signals have been received, i.e., if an audio recording apparatus is connected thereto. If so, step S54 is performed; otherwise, the step S54 will not performed until the audio recording has been connected thereto. It should be noted that if the user does not want to record the sound occurred on a navigating route or a travel route, the step S53 can be omitted.

In step S54, it is checked if the original video signals have been received, i.e., if the video recording apparatus can perform video recording. If so, step S55 is performed; otherwise, the step S55 will not be performed until the video recording apparatus is allowed to perform video recording.

In step S55, the plurality of original audio signals that have been received according to an audio standard is encoded to generate an audio stream. It should be noted that if the user does not want to record the sound occurred on a navigating route or a travel route, the step S55 can be omitted. In addition, the above audio standard may be MP3 audio standard, AAC audio standard, WMA audio standard, WAV audio standard, or OGG audio standard.

In step S56, the sizes of the plurality of original video frames that have been received are reduced to conform to the video size set by the user. Then, in step S57, the original video frames with reduced sizes are encoded according to a video standard to generate a video stream. The video stream includes the plurality of video frames. In practical application, the video standard of the video stream may be Motion-JPEG standard, ITU-T video standard, MPEG-1 standard, MPEG-2 standard, MPEG-4 standard, or Xvid standard.

Then, in step S58, the video stream and the audio stream are taken to construct a dynamic data stream. If no audio stream is generated, in step S58, the video stream is regarded as the dynamic data stream. Thereafter, in step S59, at least one trip information and at least one corresponding video frame of the dynamic data stream are taken to construct trip video data. The detailed implementation of step S59 is the same as that described above. According to the above manner, an implementation of step S59 is to embed at least one batch of trip information into the header or redundant bits of at least one corresponding video frame. If the dynamic data stream is an example having the audio stream, the implementation of step S59 is to embed at least one batch of trip information into the header or redundant bits of an audio signal so as to generate trip video data.

Definitely, if the video stream of the dynamic data stream includes multiple video information, in step S59, the link relationship between at least one trip information and the corresponding video information are recorded and the link relationship and the trip information are packaged into the link data. Then, the link data is combined into a link file, and the link file is the trip video data.

Finally, in step S60, it is checked if the power supply of the video recording apparatus is turned off. If so, the video recording process is completed; otherwise, the procedure returns to, but not limited to, the step S52, and definitely, the procedure may return to other steps.

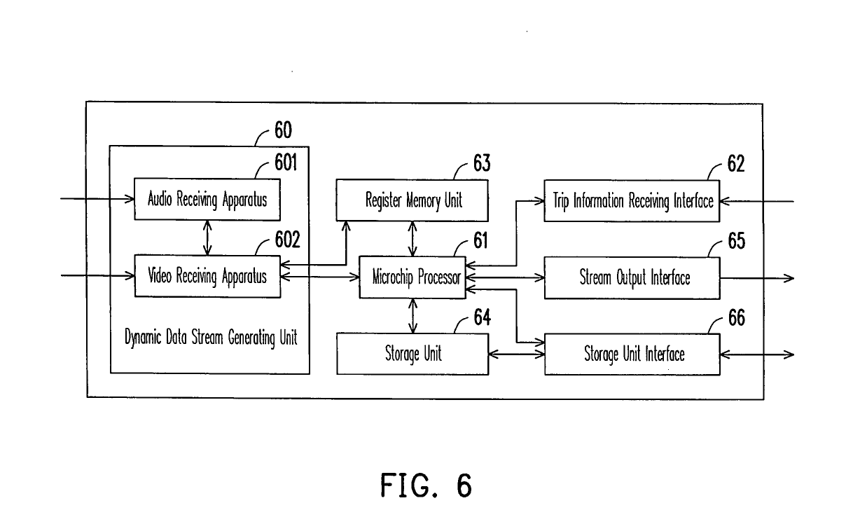

FIG. 6 is a system block diagram of an apparatus for processing trip information and dynamic data streams according to an embodiment of the present invention. Referring to FIG. 6, the apparatus includes a dynamic data stream generating unit 60, a microchip processor 61, a trip information receiving interface 62, a register memory unit 63, a storage unit 64, a stream output interface 65, and a storage unit interface 66. The dynamic data stream generating unit 60 is coupled to the microchip processor 61 and the register memory unit 63. The microchip processor is coupled to the storage unit 64, the trip information receiving interface 62, the stream output interface 65, and the storage unit interface 66. The storage unit 64 is coupled to the storage unit interface 66.

The trip information receiving interface 62 is used to receive multiple trip information. The dynamic data stream generating unit 60 is used to generate the dynamic data stream. The dynamic data stream includes a plurality of video frames. The microchip processor 61 receives the plural batches of trip information and the plurality of video frames, and is used to take at least one trip information and at least one corresponding video frame of the dynamic data stream to construct the trip video data.

The trip video data may be constructed in the aforementioned manner, and the details will not be described herein again. In addition, geographic information in the trip information received by the trip information receiving interface 62 may be transmitted from the GPS module, Internet, radio network, or cell phone. The status of navigator in the trip information is transmitted from the navigation computer.

It should be noted that the register memory unit 63 is not an essential element in this embodiment. The register memory unit 63 is merely used to temporarily store the output data of elements connected thereto, so as to avoid the data loss usually occurred when the microchip processor 61 is too busy. The register memory unit 63 may include a dynamic memory or a flash memory, which is not intended to limit the present invention.

The dynamic data stream generating unit 60 includes an audio receiving apparatus 601 and a video receiving apparatus 602. The audio receiving apparatus 601 is coupled to the video receiving apparatus 602. The video receiving apparatus 602 is used to receive a plurality of original video frames, reduce sizes of the plurality of original video frames, and encode the original video frames with reduced sizes according to a video standard, so as to generate a video stream. The video stream includes the aforementioned video frames. The audio receiving apparatus 601 is used to receive a plurality of original audio signals and encode the plurality of original audio signals according to an audio standard, so as to generate an audio stream. The video receiving apparatus 602 is further used to take the video stream and the audio stream to construct the dynamic data stream.

If the user does not want to record the sound occurred on a navigating route or a travel route, the audio receiving apparatus 601 may be removed. In this case, the dynamic data stream includes only the video stream. In addition, the audio signals and the original video frames received by the audio receiving apparatus 601 and the video receiving apparatus 602 may be transmitted from a digital video camera and the like.

The storage unit interface 66 is used to output the trip video data to an external storage unit, and the internal storage unit 64 is used to store the trip video data. In addition, the stream output interface 65 is used to output the trip video data to a playback apparatus that playbacks the trip video data, and thus the playback apparatus can display the video frames and the trip information at the same time.

It should be noted that the storage unit 64 is also coupled to the storage unit interface 66, so the storage unit interface 66 can also output the trip video data stored by the storage unit 64 to the external storage unit. The storage unit interface 66 may be a universal serial bus (USB) connection port. Definitely, the implementation of the storage unit interface 66 is not intended to limit the present invention.

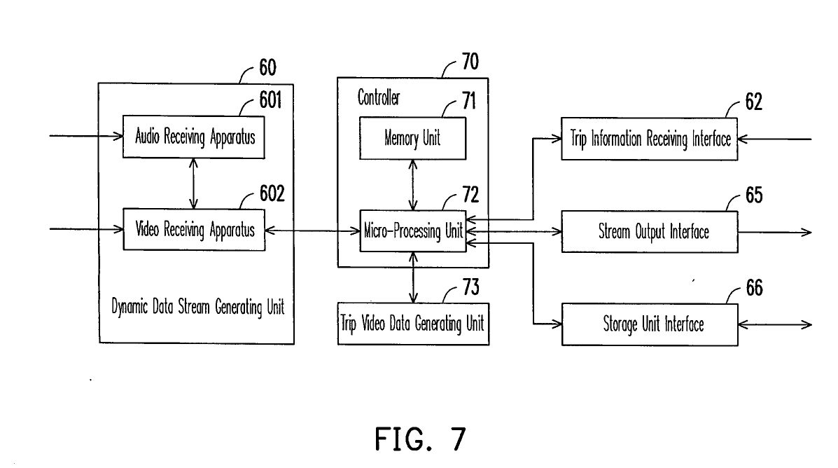

FIG. 7 is a controller for processing trip information and dynamic data streams according to an embodiment of the present invention. Referring to FIG. 7, the controller 70 includes a micro-processing unit 72 and a memory unit 71. The memory unit 71 is coupled to the micro-processing unit 72. The micro-processing unit 72 is used to control other units connected to the controller, such as a dynamic data stream generating unit 60, a trip video data generating unit 73, a trip information receiving interface 62, a stream output interface 65, and a storage unit interface 66 as shown in FIG. 7. The memory unit 71 includes program codes. When the program codes are executed, the micro-processing unit 72 controls the other units connected to the controller to perform the following steps. (a) A dynamic data stream having a plurality of video frames is received from the dynamic data stream generating unit 60. (b) Plural batches of trip information are received from the trip information receiving interface. (c) The trip video data generating unit is controlled to take at least one trip information and at least one corresponding video frame of the dynamic data stream to construct trip video data. The manner for constructing trip video data has been described in detail in the above embodiment, which, hence, will not be described herein again.

In addition, the micro-processing unit 72 may also control the stream output interface 65 whether to output the trip video data generated by the trip video data generating unit 73, or control the storage unit interface 66 to output the trip video data generated by the trip video data generating unit 73 to an external storage unit for storage. Definitely, the stream output interface 65 and the storage unit interface 66 may be omitted and are not intended to limit the present invention.

To sum up, the present invention provides a method and an apparatus for processing trip information and dynamic data streams, and a controller thereof, so as to generate trip video data including the trip information. Therefore, the user can retrieve the corresponding video frames according to the trip information or the time when the content of the trip video data is played back, so that the user can retrieve the video frames conveniently. In addition, since the trip information is included in the trip video data, so in the course of the playback, the trip information and video frames can be synchronously displayed, thereby achieving a better supervision performance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for processing trip information and dynamic data streams, comprising:
receiving a dynamic data stream, wherein the dynamic data stream comprises a plurality of video frames;
receiving plural batches of trip information; and
taking at least one batch of trip information and at least one corresponding video frame of the dynamic data stream to construct trip video data.

2. The method according to claim 1, wherein the trip video data comprises the at least one trip information and a video frame corresponding to the at least one trip information in the dynamic data stream.

3. The method according to claim 2, wherein the trip information is embedded into a header or redundant bits of the video frame.

4. The method according to claim 1, wherein the trip video data records a link relationship between the at least one trip information and the at least one video frame of the dynamic data stream.

5. The method according to claim 2, wherein the dynamic data stream further comprises an audio stream, wherein the audio stream comprises a plurality of audio signals corresponding to all the video frames, the trip video data further comprises an audio signal corresponding to the video frame, and the trip information is embedded into a header or redundant bits of the audio signal corresponding to the video frame.

6. The method according to claim 1, wherein a number of trip information is smaller than or equal to that of the video frames.

7. The method according to claim 1, wherein the trip information comprises a longitude/latitude, an altitude, a road name, a time, a velocity, a traveling direction, a fuel level, an engine temperature, or an engine rotation speed.

8. The method according to claim 1, further comprising:
receiving a plurality of original video frames;
reducing sizes of the plurality of original video frames; and
encoding the original video frames with reduced sizes according to a video standard to generate the dynamic data stream.

9. The method according to claim 8, wherein the video standard is Motion-JPEG standard, ITU-T video standard, MPEG-1 standard, MPEG-2 standard, MPEG-4 standard, or Xvid standard.

10. The method according to claim 5, further comprising:
receiving a plurality of original video frames;
receiving a plurality of original audio signals;
reducing sizes of the plurality of original video frames;
encoding the original video frames with reduced sizes according to a video standard to generate a video stream, wherein the video stream comprises the plurality of video frames;
encoding the plurality of original audio signals according to an audio standard to generate an audio stream; and
taking the video stream with the audio stream to construct the dynamic data stream.

11. The method according to claim 9, wherein the audio standard is MP3 audio standard, AAC audio standard, WMA audio standard, WAV audio standard, or OGG audio standard.

12. An apparatus for processing trip information and dynamic data streams, comprising:
a trip information receiving interface, for receiving plural batches of trip information;
a dynamic data stream generating unit, for generating a dynamic data stream, wherein the dynamic data stream comprises a plurality of video frames; and
a microchip processor, coupled to the trip information interface and the dynamic data stream generating unit, for taking at least one batch of trip information and at least one corresponding video frame of the dynamic data stream to construct trip video data.

13. The apparatus according to claim 12, wherein the trip video data comprises the at least one trip information and a video frame corresponding to the at least one trip information in the dynamic data stream.

14. The apparatus according to claim 12, wherein the trip information is embedded into a header or redundant bits of the video frame.

15. The apparatus according to claim 12, wherein the trip video data records a link relationship between the at least one trip information and the at least one video frame of the dynamic data stream.

16. The apparatus according to claim 13, wherein the dynamic data stream further comprises an audio stream, wherein the audio stream comprises a plurality of audio signals corresponding to each video frame, the trip video data further comprises an audio signal corresponding to the video frame, and the trip information is embedded into a header or redundant bits of the audio signal corresponding to the video frame.

17. The apparatus according to claim 12, wherein a number of the trip information is smaller than or equal to that of the video frames.

18. The apparatus according to claim 12, wherein the trip information comprises a longitude/latitude, an altitude, a road name, a time, a velocity, a traveling direction, a fuel level, an engine temperature, or an engine rotation speed.

19. The apparatus according to claim 12, wherein the dynamic data stream generating unit further comprises:
a video receiving apparatus, for receiving a plurality of original video frames and reducing sizes of the plurality of original video frames, and encoding the original video frames with reduced sizes according to a video standard, so as to generate the dynamic data stream.

20. The apparatus according to claim 19, wherein the video standard is Motion-JPEG standard, ITU-T video standard, MPEG-1 standard, MPEG-2 standard, MPEG-4 standard, or Xvid standard.

21. The apparatus according to claim 16, wherein the dynamic data stream generating unit further comprises:
a video receiving apparatus, for receiving a plurality of original video frames and reducing sizes of the plurality of original video frames, and encoding the original video frames with reduced sizes according to a video standard, so as to generate a video stream, wherein the video stream comprises the video frames; and
an audio receiving apparatus, coupled to the video receiving apparatus, for receiving a plurality of original audio signals and encoding the original audio signals according to an audio standard, so as to generate an audio stream;
wherein the video receiving apparatus further takes the video stream and the audio stream to construct the dynamic data stream.

22. The apparatus according to claim 21, wherein the audio standard is MP3 audio standard, AAC audio standard, WMA audio standard, WAV audio standard, or OGG audio standard.

23. The apparatus according to claim 12, further comprising:
a storage unit interface, for outputting the trip video data to an external storage unit.

24. The apparatus according to claim 12, further comprising:
a storage unit, for storing the trip video data.

25. A controller, adapted for processing trip information and dynamic data streams, comprising:
a micro-processing unit, for controlling other units connected to the controller; and
a memory unit, coupled to the micro-processing unit, and comprising program codes, wherein when the program codes are executed, the micro-processing unit controls the other units connected to the controller to perform steps:
receiving a dynamic data stream, wherein the dynamic data stream comprises a plurality of video frames;
receiving plural batches of trip information; and
taking at least one batch of trip information and at least one corresponding video frame of the dynamic data stream to construct trip video data.

26. The controller according to claim 25, wherein the trip video data comprises the at least one trip information and a video frame corresponding to the at least one trip information in the dynamic data stream.

27. The controller according to claim 26, wherein the trip information is embedded into a header or redundant bits of the video frame.

28. The controller according to claim 25, wherein the trip video data records a link relationship between the at least one trip information and the at least one video frame of the dynamic data stream.

29. The controller according to claim 26, wherein the dynamic data stream further comprises an audio stream, wherein the audio stream comprises a plurality of audio signals corresponding to each video frame, the trip video data farther comprises an audio signal corresponding to the video frame, and the trip information is embedded into a header or redundant bits of the audio signal corresponding to the video frame.

30. The controller according to claim 25, wherein a number of the trip information is smaller than or equal to that of the video frames.

31. The controller according to claim 25, wherein the trip information comprises a longitude/latitude, an altitude, a road name, a time, a velocity, a traveling direction, a fuel level, an engine temperature, or an engine rotation speed.

32. The controller according to claim 25, wherein a video standard of the video frame is Motion-JPEG standard, ITU-T video standard, MPEG-1 standard, MPEG-2 standard, MPEG-4 standard, or Xvid standard.

33. The controller according to claim 29, wherein an audio standard of the audio signal is MP3 audio standard, AAC audio standard, WMA audio standard, WAV audio standard, or OGG audio standard.
